(19) United States
(12) Patent Application Publication
(10) Pub. No.: US 2023/0260134 A1
(43) Pub. Date: Aug. 17, 2023

(54) SYSTEMS AND METHODS FOR MONITORING SUBJECTS

(71) Applicant: DARVIS INC., San Francisco, CA (US)

(72) Inventors: Ingo NADLER, Breising (DE); Jan-Philipp MOHR, Hamburg (DE)

(21) Appl. No.: 18/004,774

(22) PCT Filed: Jul. 9, 2021
(86) PCT No.: PCT/IB2021/056180

§ 371 Date: Jan. 13, 2022

Related U.S. Application Data
(60) Provisional application No. 63/049,678, filed on Jul. 9, 2020.

(51) Int. Cl. G06T 7/20; G01S 13/86; G06V 10/25; G06V 10/141; G06F 3/16; G01S 13/72

(52) U.S. Cl. CPC G06T 7/20; G01S 13/72; G01S 13/867; G06F 3/16; G06V 10/25; G06V 10/141; G06T 2207/30196; G06T 2207/30232

(57) ABSTRACT

Disclosed is a system for monitoring a subject. The system comprises image capturing arrangement comprising image sensor configured to capture one or more images of scan area; radar arrangement, operatively coupled to image capturing arrangement, wherein radar arrangement is configured to track subject in a region of scan area by using a cluster of radar reflections to detect macro-movement of the subject, define bounding box corresponding to the macro-movement, define aspect ratio of bounding box, and detect micro-movement of subject, when change in aspect ratio is observed; and processing arrangement configured to receive image data from image capturing arrangement and radar data from radar arrangement, analyse the image data and the radar data to determine the change in the aspect ratio, and trigger an emergency protocol when change in the aspect ratio is observed, or a value corresponding to the micro-movement differs from predefined range.

### TECHNICAL FIELD

The present disclosure relates generally to monitoring systems; and more specifically, to systems for monitoring subjects such as elderly patients, for improving safety and quality of life thereof. The present disclosure also relates to methods of monitoring subjects using the aforementioned systems.

### BACKGROUND

A monitoring system serves as a digital safeguard for ensuring a better quality of life for people and animals alike. The monitoring systems provide advanced social monitoring and prevention from unexpected events. Currently, a variety of monitoring systems, such as a closed-circuit television (CCTV), a wireless home security system, a video surveillance camera, floor-based fall sensors, ultrasound motion detectors, and an AI/IoT-based video surveillance camera, are available based on a user’s requirements.

Typically, CCTV systems incorporate video coverage and security alarms for intrusion detection and access control. Conventional CCTV systems are most often used to provide surveillance of larger areas, such as houses, buildings, and professional settings. One such application of CCTV systems is for monitoring the safety of children, in environments such as a home, a child day care or a preschool. However, the monitoring systems used for this purpose are limited to a person who has a primary access to the feed. This limitation further leads to an increase in the cost of the system, thereby making the system inefficient. Another application of CCTV systems is for monitoring one or more people, such as an elderly person and/or a patient suffering from one or more health-related issues, such as dementia, other chronic illnesses or disabilities, who may be accommodated in places such as residence, assisted living facilities or nursing homes.

Normally, such elderly people and/or patients are supported with a Long-term care (LTC) service besides CCTV systems. The LTC service substantially caters to both the medical and the non-medical needs of such people and/or patients. LTC services are still fundamental in various parts of the world, and face limitations such as shortages of workforce, abuse, neglect, unmet resident needs, quality problems with training and competence, and a lack of integration with medical facilities.

Recent advances in monitoring systems have delivered AI-based systems, IoT-based smart surveillance systems, and the like. However, such systems still lack user-friendly features, the ability to track the person, or the ability to prevent an unexpected event, and are rendered complex in terms of installation thereof. Moreover, the AI- or IoT-based monitoring systems may trigger false alarms or may find it difficult to connect with the emergency responder during an emergency, thereby causing a delay in required assistance from the responder.

Therefore, in light of the foregoing discussion, there exists a need for improved systems for monitoring subjects.

### SUMMARY

The present disclosure seeks to provide a system for monitoring a subject. The present disclosure also seeks to provide a method for monitoring a subject. The present disclosure seeks to provide a solution to the existing problem of monitoring and tracking subjects, such as elderly and/or patients. An aim of the present disclosure is to provide a solution that overcomes at least partially the problems encountered in prior art.

In one aspect, an embodiment of the present disclosure provides a system for monitoring a subject, the system comprising:
an image capturing arrangement comprising an image sensor configured to capture one or more images of a scan area;
a radar arrangement, operatively coupled to the image capturing arrangement, wherein the radar arrangement is configured to track the subject in a region of the scan area by using a cluster of radar reflections to
   detect a macro-movement of the subject,
   define a bounding box corresponding to the macro-movement,
   define an aspect ratio of the bounding box, and
   detect a micro-movement of the subject, when a change in the aspect ratio is observed; and
a processing arrangement configured to
   receive an image data from the image capturing arrangement and a radar data from the radar arrangement,
   analyse the image data and the radar data to determine the change in the aspect ratio, and
   trigger an emergency protocol when
      the change in the aspect ratio is observed, or
      a value corresponding to the micro-movement differs from a predefined range.

In another aspect, an embodiment of the present disclosure provides a method for monitoring a subject using the aforementioned system, the method comprising:
capturing one or more images of a scan area;
tracking the subject in a region of the scan area, by using a cluster of radar reflections for
   detecting a macro-movement of the subject,
   defining a bounding box corresponding to the macro-movement,
   defining an aspect ratio of the bounding box, and
   detecting a micro-movement of the subject, when a change in the aspect ratio is observed;
receiving an image data and a radar data;
analysing the image data and the radar data to determine the change in the aspect ratio; and
triggering an emergency protocol when
   the change in the aspect ratio is observed, or
   a value corresponding to the micro-movement differs from a predefined range.

Embodiments of the present disclosure substantially eliminate or at least partially address the aforementioned problems in the prior art, and provides an efficient and user-friendly system for tracking the subject, detecting changes in macro-movements and micro-movements of the subject, and triggering an emergency protocol in real-time, thereby, preventing casualties.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a system for monitoring a subject, in accordance with an embodiment of the present disclosure;

FIG. 2 is a schematic illustration of a system installed in an environment, in accordance with an embodiment of the present disclosure.

FIG. 3 is a schematic illustration of a region of a scan area as viewed from a radar arrangement, in accordance with an embodiment of the present disclosure;

FIG. 4 is a schematic illustration of a captured and streamed video of a subject in a scan area, in accordance with an embodiment of the present disclosure;

FIG. 5 a schematic illustration of a dewarp image of a subject in a scan area, in accordance with an embodiment of the present disclosure;

FIG. 6 is a flowchart of steps of a method of monitoring a subject, in accordance with an embodiment of the present disclosure;

FIG. 7 is a flowchart illustrating steps of functioning of a radar arrangement, in accordance with an embodiment of the present disclosure;

FIG. 8 is a logic of a two-factor fall-detection, in accordance with an embodiment of the present disclosure;

FIG. 9 is an illustration of a graph depicting an exemplary Fast Fourier Transform of micro-movements, in accordance with an embodiment of the present disclosure;

FIG. 10 is an exemplary illustration of a display screen for disoriented subjects, in accordance with an embodiment of the present disclosure; and

FIG. 11 is an exemplary illustration of a display screen for a dementia patient, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a system for monitoring a subject, the system comprising:
an image capturing arrangement comprising an image sensor configured to capture one or more images of a scan area;
a radar arrangement, operatively coupled to the image capturing arrangement, wherein the radar arrangement is configured to track the subject in a region of the scan area by using a cluster of radar reflections to
   detect a macro-movement of the subject,
   define a bounding box corresponding to the macro-movement,
   define an aspect ratio of the bounding box, and
   detect a micro-movement of the subject, when a change in the aspect ratio is observed; and
a processing arrangement configured to
   receive an image data from the image capturing arrangement and a radar data from the radar arrangement,
   analyse the image data and the radar data to determine the change in the aspect ratio, and
   trigger an emergency protocol when
      the change in the aspect ratio is observed, or
      a value corresponding to the micro-movement differs from a predefined range.

In another aspect, an embodiment of the present disclosure provides a method for monitoring a subject using a system of any of the preceding claims, the method comprising:
capturing one or more images of a scan area;
tracking the subject in a region of the scan area, by using a cluster of radar reflections for
   detecting a macro-movement of the subject,
      defining a bounding box corresponding to the macro-movement,
   defining an aspect ratio of the bounding box, and
   detect a micro-movement of the subject, when change in the aspect ratio is observed;
receiving an image data and a radar data;
analysing the image data and the radar data to determine the change in the aspect ratio; and
triggering an emergency protocol when
   the change in the aspect ratio is observed, or
   a value corresponding to the micro-movement differs from a predefined range.

The present disclosure provides the aforementioned system and the aforementioned method for monitoring the subject. The system provides a two-factor verification of fall detection by using the radar data to detect falls and the image data to verify the fall, and thus prevents false alarm, as compared to the conventional approaches that use motion detectors. Additionally, the system triggers emergency protocol in real-time and enters in a call mode to contact an emergency responder of the subject to attend to the subject without a delay. The system and method provide improved safety and quality of life for the subjects, such as elderly people, patients, and so forth.

The disclosed system provides a digital safeguard for improving safety and quality of life of the subject. Throughout the present disclosure, the term “subject” as used herein refers to a person, such as an elderly person, a patient, a child, a person prone to falls or injuries, and the like. Optionally, the subject is a dementia patient or an elderly person with increasing dementia. Optionally, the subject may be accommodated within a home, a health-care facility (such as a hospital, a rehabilitation, old-age care center, and so on), a day-care facility, a prison, a factory, and so forth. Optionally, the subject is socially isolated from family thereof.

The term “monitoring” as used herein refers to a regular observation and recording of activities of the subject to ensure improved safety and quality of life thereof. Optionally, monitoring is required when the subject is in isolation, away from family or under guarded supervision. It will be appreciated that monitoring the subject using the aforementioned system safeguard the subject from mishaps, their own actions, and other unexpected events (such as burglary, fire outbreak, and so forth).

The system comprises the image capturing arrangement comprising the image sensor configured to capture one or more images of a scan area. As used herein, the term “scan area” refers to an area of an environment before the image capturing arrangement. It may be appreciated that the environment may be a property including, but not limited to, a room, a home or a building. Optionally, the image capturing arrangement may be one or more cameras comprising one or more image sensors that may be used to capture the one or more images of the scan area. Optionally, only one camera may be arranged to capture the one or more images of the scan area. Alternatively, a plurality of cameras may be arranged in a defined manner to cover the scan area entirely. Herein, images captured by each camera of the plurality of cameras may form the one or more images of the scan area. Optionally, the image capturing arrangement may capture a video of the scan area. Herein, the one or more images may be frames of each of the video captured by each camera of the plurality of cameras of the image capturing arrangement.

Optionally, the image capturing arrangement is arranged to have the scan area within a field of view thereof, and wherein the image capturing arrangement is configured to capture the one or more images when the subject is positioned within the scan area. In this regard, the image capturing arrangement may comprise the plurality of cameras arranged in the defined manner so that the scan area is in the field of view of image capturing arrangement. The image capturing arrangement may directly capture the one or more images of the subject in the scan area as required. Optionally, the image capturing arrangement comprises the plurality of cameras arranged so as to obtain a 180° vertical view and a 180° horizontal view of the subject standing in the scan area. Optionally, the image capturing arrangement may continuously capture the one or more images to detect if the subject is present in the scan area. It may be appreciated that detection of a presence of the subject in the image frame may be achieved by known object recognition techniques.

Optionally, the image capturing arrangement is configured to capture the one or more images when the subject is not positioned within the scan area. In such a case, the image capturing arrangement continuously or intermittently captures one or more images of the scan area. Optionally, the image capturing arrangement is configured to detect a smoke outbreak and/or a fire outbreak.

Optionally, the image capturing arrangement is a wide-angle camera. The wide-angle camera typically has a smaller focal length that enables capturing a wider scan area to be captured. Optionally, the wide-angle camera is a fisheye camera. The fisheye camera is an ultra-wide-angle camera configured to create a wide panoramic or hemispherical image (or non-rectilinear image). Optionally, the fisheye camera captures an angle of view of around 100-180° vertically, horizontally and diagonally. Optionally, the image capturing arrangement provides a 360° view using a specialized fisheye 360° dome camera. Optionally, the image capturing arrangement provides a resolution of at least 3 Megapixels.

Optionally, the image capturing arrangement further comprises an illuminator configured to illuminate the scan area during capturing of the one or more images. The term “illuminator” refers to equipment that, in operation, emits light. Optionally, the illuminators are configured to illuminate the scan area during capturing of the one or more images during night. Optionally, the illuminators are configured to illuminate the area in front, left and right of the device at night. Optionally, the illuminators emit light of an infrared wavelength or a near-infrared wavelength. Alternatively, optionally, the illuminator emits light of a visible wavelength. Examples of a given illuminator include, but are not limited to, infrared (IR) illuminators, light emitting diode (LED) illuminators, IR-LED illuminators, white-light illuminators, and the like. Beneficially, the emitted light of the infrared wavelength or the near-infrared wavelength is invisible (or imperceptible) to the human eye, thereby, reducing unwanted distraction when such light is incident upon the subject’s eye.

Optionally, the image capturing arrangement is trained using an AI-based program for face recognition. In this regard, the image capturing arrangement is trained to identify a person as the person faces the image capturing arrangement. Optionally, the program is configured to compare the unknown facial features of a person with known facial features of the subject in the scan area.

Optionally, the image capturing arrangement is configured to record a video and save the recorded video. The saved video may be accessed and played back as required. Optionally, a video calling program, associated with the image capturing arrangement, encodes the images captured from the image capturing arrangement and streams the images to a mobile application (mobile app) associated with the system and integrated within a user device (described later). Moreover, the video calling program decodes the video stream coming in from the mobile application and displays it on a display screen of the system. Optionally, the video calling program enables display of text, such as the name of the person calling, and/or an image of the person calling.

Optionally, the image capturing arrangement is configured to enable hands free video calls. In this regard, the system uses contact details associated with a contact person that are stored in the memory unit during an emergency or user call mode. The image capturing arrangement works in conjunction with the processing arrangement to recognize the gesture, voice, facial gestures in the respective language of the subject. For example, the gesture could be a swiping of a hand in front of the display screen that is assumed as a command to end the call. Alternatively, the radar arrangement works along with the image capturing arrangement to track the subject and analyze the gestures of the subject during the video call. For example, the movement of the subject away from the display screen is assumed as a command to end the ongoing video call.

The system comprises the radar arrangement, operatively coupled to the image capturing arrangement, configured to track the subject in a region of the scan area by using a cluster of radar reflections. The radar arrangement is activated to enter a tracking mode, when the image capturing arrangement locates the subject in the scan area. The term “radar arrangement” refers to a detection system that uses radio waves to determine motion and velocity of the subject (or any object), by figuring out change in a position, a shape, a trajectory, an angle thereof. In this regard, the radar reflections from a transmitter of the radar arrangement reflects off the subject (or object) and returns to a receiver of the radar arrangement, giving information about the subject’s (or object’s) location and velocity. Optionally, the radar arrangement is a millimeter wave (mmwave) radar sensor, such as Texas Instruments IWR 4368AOP chipset, and the like. Beneficially, such radar reflections are safe for organisms (both humans and animals), and therefore the radar arrangement finds use in a wide range of applications such as in wearable devices, smart buildings, automobiles, control systems, and so forth.

It will be appreciated that the term “region of the scan area” refers to a section of the scan area in which the subject (or object) needs to be tracked. Specifically, the region is defined by the height and width (or cross-section) of the subject (or object). Moreover, selection of the region corresponds to which part of an image frame is the focus for tracking of the subject (or object). Optionally, the scan area may have portions where only non-moving objects may be placed. The tracking of the subject (or object) may not be necessary in such portions of the scan area. Therefore, in order to conserve energy and computational cost, it will be appreciated that only the region of the scan area where a moving subject (or object) may be tracked is selected, and portions where subject (or object) may unlikely be ever placed are ignored.

Moreover, the cluster of radar reflections are employed to
detect a macro-movement of the subject,
define a bounding box corresponding to the macro-movement,
define an aspect ratio of the bounding box, and
detect a micro-movement of the subject, when a change in the aspect ratio is observed.

In this regard, the radar arrangement, being operatively coupled to the image capturing arrangement, is activated when the image capturing arrangement locates the subject in the scan area. The radar reflections reflect off the subject towards the receiver and analyzed to track the motion of the subject. Based on the motion of the subject, a change in the wave frequency or Doppler effect is observed and said change is associated with at least one macro-movement. The macro-movement typically includes, but is not limit to, walking, sitting, laying, bending, falling.

Moreover, for the selected region of the scan area where the macro-movement is detected, the radar reflections are used to define a bounding box corresponding to the macro-movement. In this regard, the image frame focusing on the subject is processed, by the processing arrangement, to determine one or more dimensions. The one or more dimensions may be physical dimensions, such as, but not limited to length, breadth, width, height, angle made by different body parts with respect to a central axis of the subject. The one or more dimensions eventually define the bounding box corresponding to the macro-movement of the subject.

Furthermore, for a given bounding box, an aspect ratio of the given bounding box is defined. The term “aspect ratio” as used herein refers to a ratio of a longer side (height) of a geometric shape to its shorter side.

In an embodiment, the aspect ratio is a ratio of the height of the bounding box to the width thereof if the bounding box is oriented as a portrait. In another embodiment, the aspect ratio is a ratio of the width of the bounding box to the height thereof if the bounding box is oriented as a landscape. It will be appreciated that two aspect ratios of the bounding box may be relative to each other. Specifically, if a first aspect ratio is obtained for the bounding box in the portrait-orientation, then a second aspect ratio is also obtained for the bounding box in the portrait-orientation.

Furthermore, radar arrangement is configured to detect a micro-movement of the subject, when change in the aspect ratio is observed. The term “change in the aspect ratio” refers to a difference in the values of two aspect ratios when measured as a function of time. The change may be a rapid (or sudden) change, or a slow change as measured during a period of time. The change in the aspect ratio corresponds to a change in the macro-movement of the subject. The micro-movement refers to the ultra-precise displacement and motion associated with the life signs of the subject. Optionally, the micro-movement include, but not limited to, life sign physiological parameters, such as, heartbeat frequency, respiratory movements, muscle movements, and so on. Specifically, based on velocity measurements and signal phase changes of incoming radar reflections, the micro-movement of the chest of the subject is measured along with any other muscular movement. It will be appreciated that the muscular movement may not yield a regular frequency pattern, as a result a fast Fourier transform (FFT) may be run on the micro-movement data to determine if a respiratory or heart rate frequency can be extracted from the data. However, if the image capturing arrangement locates the subject in the scan area but the radar arrangement does not detect any motion, it is assumed that the subject is dead.

It will be appreciated that alternate systems, such as LIDAR, similar to radar but using other wavelength ranges of the electromagnetic spectrum, such as infrared radiations from lasers rather than radio waves, could be used. It will be appreciated that the LIDAR and other systems deliver a point cloud data to be analyzed.

Optionally, the system is arranged to be mounted on a wall of the environment (such as a room), such that the image capturing arrangement is at just above the eye level of an adult and the radar reflections are angled down roughly at the center of the environment’s floor.

The system comprises the processing arrangement. The term “processing arrangement” refers to an application, program, process or device that responds to requests for information or services by another application, program, process or device (such as the external device) via a network interface. Optionally, the processing arrangement also encompasses software that makes the act of serving information or providing services possible. It may be evident that the communication means of the external device may be compatible with a communication means of the processing arrangement, in order to facilitate communication therebetween.

The processing arrangement is configured to receive the image data from the image capturing arrangement and the radar data from the radar arrangement. It will be appreciated that the image capturing arrangement and the radar arrangement, respectively, sense and gather the image data and the radar data corresponding to a scan area and the subject located in the scan area, and communicate with the processing arrangement for processing of the image data and radar data. The processing arrangement of the system processes the received image data and radar data using a plurality of programs, such as the control program.

In this regard, the control program manages configurations of the image capturing arrangement and the radar arrangement, and invokes or ends other programs that work on the image data and radar data. Moreover, the control program configures the radar arrangement to track the subject, and process the corresponding tracking data to determine a relative position of the subject with respect to the radar arrangement. Furthermore, the control program configures the radar to monitor the subject’s immobile sitting or lying down by measuring basic life signs, such as the respiratory rate, and so on, to determine a state (alive, sleeping or dead) of the subject.

Optionally, the control program reconfigures the radar arrangement on the fly to switch between a maximum range coverage (for detecting macro-movements) and a minimum range coverage (for detecting micro-movements) with ultra-high velocity resolution. In this regard, the control program sends different chirp configurations and potentially a new firmware to the radar arrangement and eventually resets the radar arrangement. Moreover, during micro-movement detection, the incoming radar reflections are still clustered, and the control program determines the bounding box aspect ratio to check if the subject is recovering and getting back up.

Optionally, when the radar arrangement does not detect any motion in the room that can be clustered into a large enough bounding box (e.g. to avoid being triggered by the cat or a curtain blowing in the wind), the device enters the idle mode and turns off the display and lowers the chirp and frame rates of the radar arrangement and the image capturing arrangement, respectively, to 5fps to conserve power and lower radiation. As soon as the motion is detected, the processing arrangement turns the display back on and begins tracking the subject.

Moreover, the processing arrangement is configured to analyse the image data and the radar data to determine the change in the aspect ratio. In this regard, the processing arrangement computes a change in the aspect ratio of the bounding box. Specifically, the processing arrangement computes a difference in the values of two aspect ratios as a function of time. The change may be a rapid (or sudden) change, or a slow change as measured during a period of time. Specifically, if the height of the bounding box decreases rapidly, it is determined that the subject has fallen, and if the width of the bounding box exceeds its height, the fall is verified. However, if the aspect ratio of the bounding box (height:weight) changes slowly, it is assumed that the subject has either sat or laid down.

Furthermore, the processing arrangement is configured to trigger the emergency protocol when the change in the aspect ratio is observed, or the value corresponding to the micro-movement differs from the predefined range. The term “emergency protocol” as used herein refers to a series of actions in response to an emergency. The emergency typically poses an immediate risk to health, life, property, or the environment. The term “predefined range” refers to a defined therapeutic range associated with one or more life signs of the subject. For example, a normal respiratory rate of an adult person may range from 12 to 16 breaths per minute. Optionally, the emergencies include, but not limited to a fall detection for the subject, smoke and/or fire detection, inconsistency in micro-movement of the subject. It will be appreciated that each emergency has a different emergency protocol.

Optionally, the emergency protocol triggers an emergency alert, wherein the emergency alert is contacting an authorised carer of the subject. Optionally, the emergency alert includes, but is not limited to, involvement of qualified personnel, suggesting specific actions to be undertaken in response to different emergencies, and reporting requirements. More optionally, the emergency alert includes contacting the contact person, such as a supervisor of the subject (such as a health-care professional, a warden, a carer, and so forth), a family member of the subject, a third-party associate (such as a fire brigade in case of smoke or fire outbreak, a police in case of a burglary, and so forth), and so on. In another example, the emergency protocol initiates raising an alarm for nursing staff, for example. In another example, the emergency protocol initiates video calling, such as a family member of the subject. In such a case, when the emergency protocol is commenced, the processing arrangement attempts to establish a video call connection with one or more contact persons found in a contacts database from top to bottom. These contact persons can then access the communication interface and determine if emergency responders have to be notified. If no such connection can be established within a certain time, the processing arrangement may call an emergency care service. Also, for forensic analysis, it may then record video and audio and upload it to a secure cloud location.

Optionally, the processing arrangement is further configured to implement an artificial-intelligence-based object recognition algorithm to analyze the radar data and trigger the emergency protocol. Optionally, the image capturing arrangement is trained using artificial intelligence (AI) models to detect the subject in the scan area. More optionally, the AI model implements an object recognition algorithm on the image data to locate the subject in the scan area. Optionally, the object recognition algorithm may be employed to analyze the image data and the radar data to detect the macro-movement of the subject and determine if the subject is injured, lying down, sitting or sleeping. Moreover, information corresponding to the micro-movement (namely, life sign information) of the subject may be transmitted via a mobile app during the emergency protocol, along with the video stream, so that the contact person can check the health of the subject while looking at the video stream.

Optionally, the image capturing arrangement is trained using artificial intelligence (AI) models to detect the smoke and/or fire outbreak. In this regard, in an idle mode and tracking mode, the object recognition algorithm is implemented on the image data to detect smoke and/or fire outbreak. If a smoke and/or fire outbreak is detected over a continuous period of time (such as for a few seconds), the emergency protocol is commenced and the system instructs the subject to leave the site and wait for help. It will be appreciated that the AI models trained on fire and/or smoke may be contemplated by a person skilled in the art. Optionally, the AI model for smoke detection is trained using synthetic data from an inverse (i.e. upside down) fluid simulation that mimics the behavior of smoke in closed spaces, filling the room with virtual smoke pouring into an upside-down room model from different origins. In most cases, the cause of the smoke is not visible in the camera’s direct sight, so it will ‘roll in’ into the view from the side. As it is nearly impossible to obtain real footage for AI training, the AI model therefore may be trained on photorealistic synthetic data using different shades of smoke (from white to black) to enhance generalization capabilities or efficiency of the image capturing arrangement. Optionally, the AI models are trained based on observations such as origins, smoke thickness and color.

Moreover, when the radar arrangement tracks a person coming close to the system, it reconfigures the processing arrangement analyzing the smoke and/or fire outbreak (ideal mode) to face & facial feature recognition (tracking mode). If a face is found and it is determined that it is facing the device, its facial features are compared to the subject’s facial features for identification. If said identification is positive, the device enters the call mode. Optionally, in the call mode, the processing arrangement scrolls through the contacts database starting at the most frequently or most recently called contact person. For each entry, it shows a picture of the contact person and his name on the screen. It then asks the subject if he wants to call this contact person. The image capturing arrangement and the microphone are then used to determine if the subject nods, says ‘YES’ shakes his head, and/or says ‘NO’ using gesture and/or voice recognition known in the art. It will be appreciated that the gesture and/or voice recognition are trained using machine-learning tools, to understand the gesture and/or voice in the respective languages as per various country or social traditions. If the subject agrees to the call, the video call is initiated to the mobile app of that contact person. Moreover, during the call, the radar arrangement continues to track the subject. If the subject moves away from the system, it is determined that the subject wants to end the call and the call is ended. Optionally, if a gesture (e.g. swiping a hand in front of the screen) is detected by the radar arrangement to end the call, then the call is ended.

Optionally, the processing arrangement is further configured to implement Fourier analysis algorithms to analyze the micro-movement of the subject. In an embodiment, the Fourier analysis algorithms are Fast Fourier analysis algorithms. In another embodiment, the Fourier analysis algorithms are Discrete Fourier analysis algorithms. The Fourier analysis algorithms are implemented on the radar data, such as when the subject’s bounding box is wider than high, i.e. in a state of sitting or lying down, to yield spikes at the heart rate and respiratory rate frequencies, respectively. From such results it is assumed that the subject is alive and sleeping. Moreover, the Fourier analysis algorithms may be implemented to additionally analyze audio to check for sighs, screams, moans and sounds of distress to confirm a corresponding state of the subject. Optionally, the subject may be attached to various devices, such as a wearable device, operable to measure vital life signs of the subject directly. Optionally, the system may use a wireless protocol, such as Bluetooth™, to interface with such wearable devices.

Optionally, the system further comprises
a communication interface having
   a display screen configured to display text or graphics thereon;
   a microphone configured to receive an audio input from the subject, and
   a speaker configured to provide an audio output to the subject;
a memory module configured to store data associated with the subject; and
a network interface.

In this regard, optionally, the communication interface includes, but are not limited to, microphone, display screen, touch screen, optical markers, and speakers. The display screen is typically large enough to show in big size (namely, clearly) the text and graphics, comprising pictures and/or videos. Examples of the display screen include, but are not limited to, a Liquid Crystal Display (LCD), a Light-Emitting Diode (LED)-based display, an Organic LED (OLED)-based display, a micro OLED-based display, an Active Matrix OLED (AMOLED)-based display, and a Liquid Crystal on Silicon (LCoS)-based display. The microphones may be used to receive (or record) audio streams. Further, the audio streams from the subject may be sent to processing arrangement in real time. Optionally, the audio streams may be pre-recorded by the subject using the microphone for play-back using the speaker, as required. Moreover, the speaker may be used to play music or providing instructions to the subject. Furthermore, the speakers enable the subject to hear out the contact person during a call.

The memory module is configured to store a list of contact persons and data related thereto, pictures and descriptions thereof, videos and descriptions thereof, notes, appointments, change in the radar data, change in image data, information corresponding to the micro-movement, and so forth. The data related to a contact person include a name, a picture, contact details such as mobile number, email id, one or more social network profiles and so on, a relationship, a special occasion such as birthday, an anniversary, an appointment, and so on. Herein, the memory module may be any storage device implemented as hardware, software, firmware, or combination of these. In an embodiment, the memory module may be a primary memory such as a read only memory (ROM) and a random-access memory (RAM), that may be faster. In another embodiment, the memory module may be a secondary memory, such as hard disk drives, secondary storage disks, floppy disks and the like.

The network interface may typically be an individual network, or a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks. Optionally, the network interface enables communication between the various components of the system such as the image capturing arrangement, radar arrangement, and one or more external devices. Optionally, the network interface is employed by a mobile app integrated with the user device to contact the communication interface.

The communication interface may be used to update at least one of: display of graphics and text on the display screen, a calendar database configured to store appointments, birthdays, and other important events, the contacts database configured to store emergency contact persons and pictures thereof, a graphics database configured to store pictures, videos and their descriptions, and so forth.

It will be appreciated that the elderly people frequently suffer from early dementia or disorientation. Typically, short-term memory is affected first.

In some cases, a stroke may affect other brain functions like perception of time. In later stages, the elderly people often fail to recognize people close to them. To mitigate these problems, the system has a large display screen and maintains the calendar database and the graphics database that can be accessed via the mobile app or web app by family members and caretakers. Through the mobile app or a web interface, the system can be specifically configured to the condition of the respective subject. In an example, a configurable clock may correspond to the era the subject enjoyed most, a current day of the week, a current date, a next reminder or appointment, taken from the calendar. In another example, for patients with dementia or memory loss, it may show on the entire display screen, pictures of family members or other people or places, taken from the graphics database, the names of said people or places, and other pictures from their own past with their respective names.

The term “external devices” refers to one or more devices operable to interact with the system. The external devices are operatively coupled to the system. Optionally, the external device is at least one of: one or more slave devices, an external server, a user device.

The “slave device” refers to one or more additional devices, arranged in a multi-room configuration that function similarly to the system as disclosed above. Optionally, one or more slave devices are arranged in one or more areas outside the scan area, such as in multiple rooms (such as a bedroom, a kitchen, a restroom, a lobby, and a balcony) or areas in the environment. Each slave device only contains a radar sensor, a camera sensor, and a network interface, similar in configuration or function to the radar arrangement, the image capturing arrangement, and the network interface of the system, respectively. Optionally, the one or more slave devices are configured to provide at least one of: the image data or the radar data corresponding to the one or more areas to the processing arrangement. The one or more slave devices are connected to the system through a wireless or cabled network interface. At an implementation level, in a slave mode, the one or more slave devices configure the radar sensor thereof to low power-low frame rate motion detection and send a camera image using the camera sensor for analysis to the system. Moreover, the system, in an idle mode, analyses one or more images from the image capturing arrangement and camera images from all the connected one or more slave devices with a low frame rate, such as to detect smoke and/or fire outbreak. Furthermore, the system prioritizes analysis of the respective device’s data, if a motion is detected or smoke and/or fire outbreak is detected in any of the analyzed images. Optionally, the one or more slave devices and the system coordinate their function to track a subject, such as a person suffering from dementia, across different rooms (or areas) to determine if said person leaves the house and thus commencing the emergency protocol.

The term “user device” refers to a device associated with a contact person, namely, the user. Optionally, the user device comprises the mobile app integrated therein or uses a web service or web application to interact with the system. Moreover, the user device includes communication means to facilitate communication with the processing arrangement of the system via a network interface. Examples of user devices include, but are not limited to, smartphones, laptops, tablet computers, and the like. Specifically, the contact person may operate the user device to connect, using the system, with the subject virtually or initiate an action to attend to the subject in case of emergency. The user device is configured to interact with the system, such as during the emergency protocol, or otherwise for example during a regular video call.

In an implementation, during a regular video call, initiated by the contact person, or during the emergency protocol, the system encodes and streams a quadratic 180°-180° fisheye video in e.g. 2k x 2k resolution to the mobile app or the web service. The mobile app or web service receives the video stream, decodes it and then generates a perspective video from it to be watched by the contact person. Using inputs like stroking across the screen or moving the mouse with a held down mouse button changes the horizontal or vertical view direction of the perspective video, just like moving a remote-controlled camera head.

In another implementation, the system may be used in a professional institution and used with a plurality of elderly people. In such a case, no mobile app would be used but a web application that allows e.g. a nurse or caretaker to check in on the subject in case of an emergency before heading to the room. As the system initiates the call and does not allow a general video surveillance, privacy is of no concern. It could in one embodiment show a grid of rooms with the bounding boxes generated by the system’s radar arrangement visible per room, so that the nurse can see general (and anonymized) macro-movement inside the room.

In yet another implementation, the information related to the micro-movement (or life signs) of the subject may be approximated by the system’s radar arrangement and shown per room in the web application. Moreover, when the emergency protocol is commenced, it establishes a video connection to the web application to allow the nurse or caretaker to look around with a perspective view generated from the 180°-180° fisheye view that gets streamed to the web app.

Optionally, the processing arrangement is further configured to dewarp the one or more images. The term “dewarp” refers to correction of distortions of images obtained from the image capturing arrangement such as a wide-angle camera generally equipped with a fisheye lens. The processing arrangement dewarps the one or more images (and/or camera image from one or more slave devices) and passes the dewarp image(s) for further processing.

The present disclosure also relates to the method as described above. Various embodiments and variants disclosed above apply mutatis mutandis to the method.

Optionally, the method further comprises storing data associated with the subject in a memory module.

Optionally, the method further comprises implementing Fourier analysis algorithms to analyze the micro-movement of the subject.

Optionally, the method further comprises implementing an artificial-intelligence-based object recognition algorithm to analyze the radar data and trigger the emergency protocol.

Optionally, the emergency protocol triggers an emergency alert, wherein the emergency alert is contacting an authorised carer of the subject.

Optionally, the method comprises arranging the image capturing arrangement to have the scan area within a field of view thereof, and wherein the image capturing arrangement is configured to capture the one or more images when the subject is positioned within the scan area.

Optionally, the method further comprises dewarping of the one or more images.

Optionally, the method further comprises arranging one or more slave devices in one or more areas outside the scan area, wherein the one or more slave devices are configured to provide at least one of: the image data or the radar data corresponding to the one or more areas to the processing arrangement.

The present disclosure also relates to the computer program product as described above. Various embodiments and variants disclosed above apply mutatis mutandis to the computer program product.

The computer program product comprising a non-transitory computer-readable storage medium having computer-readable instructions stored thereon, the computer-readable instructions being executable by a processing arrangement comprising multiple processing threads to execute the aforementioned method.

### DETAILED DESCRIPTION OF THE DRAWINGS

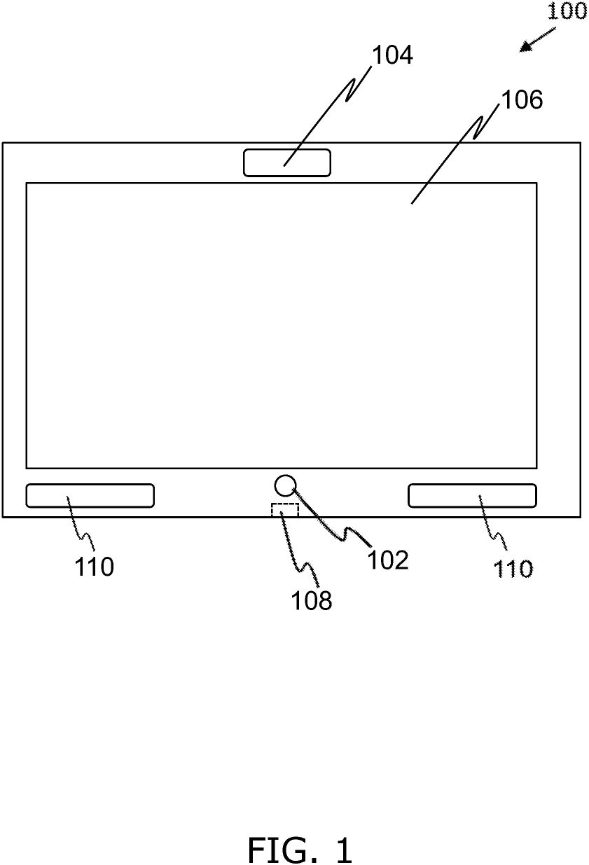

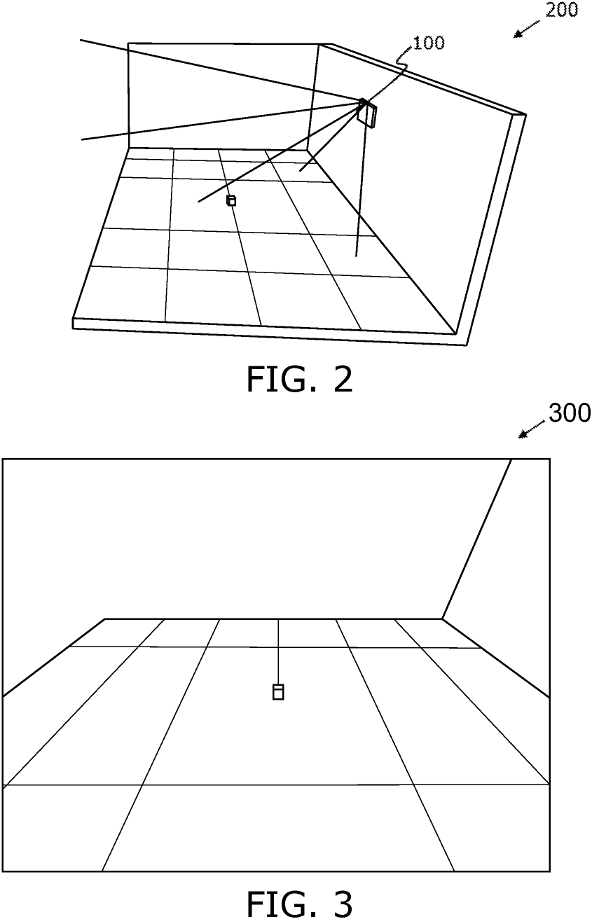

Referring to FIG. 1, illustrated is a system 100 for monitoring a subject, in accordance with an embodiment of the present disclosure. The system 100 comprises an image capturing arrangement 102, a radar arrangement 104, operatively coupled to the image capturing arrangement 102, and a processing arrangement (not shown). The image capturing arrangement 102 comprises an image sensor (not shown) configured to capture one or more images of a scan area (shown in FIG. 2). The radar arrangement 104 is configured to track the subject in a region of the scan area by using a cluster of radar reflections (shown in FIG. 2) to detect a macro-movement of the subject, define a bounding box corresponding to the macro-movement, define an aspect ratio of the bounding box, and detect a micro-movement of the subject, when a change in the aspect ratio is observed. The processing arrangement is configured to receive an image data from the image capturing arrangement 102 and a radar data from the radar arrangement 104, analyse the image data and the radar data to determine the change in the aspect ratio, and trigger an emergency protocol when the change in the aspect ratio is observed, or a value corresponding to the micro-movement differs from a predefined range.

The system 100 further comprises a communication interface comprising a display screen 106, a microphone 108, and a speaker 110. The display screen 106 is configured to display text or graphics thereon. The microphone 108 is configured to receive an audio input from the subject. The speaker 110 is configured to provide an audio output to the subject.

The system 100 further comprises a memory module and a network interface.

Referring to FIG. 2, illustrated is a system, such as the system 100 of FIG. 1, installed in an environment 200, in accordance with an embodiment of the present disclosure. As shown in FIG. 2, the environment 200 is a wall of a room. The system 100 is mounted at a height such that the image capturing arrangement 102 is at a pre-defined height, such as for example just above eye level of an adult person. As shown in FIG. 2, the lines or rays emanating from the radar arrangement of the system 100, represents the exemplary radar reflections that are employed to track the subject in the radar coverage area.

Referring to FIG. 3, illustrated is a region of a scan area 300 as viewed from the radar arrangement, such as the radar arrangement 104 of FIG. 1, in accordance with an embodiment of the present disclosure.

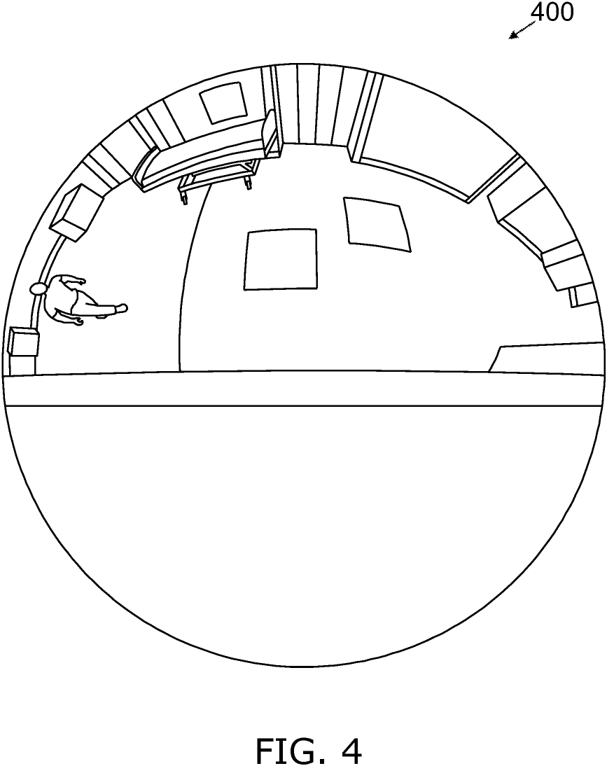

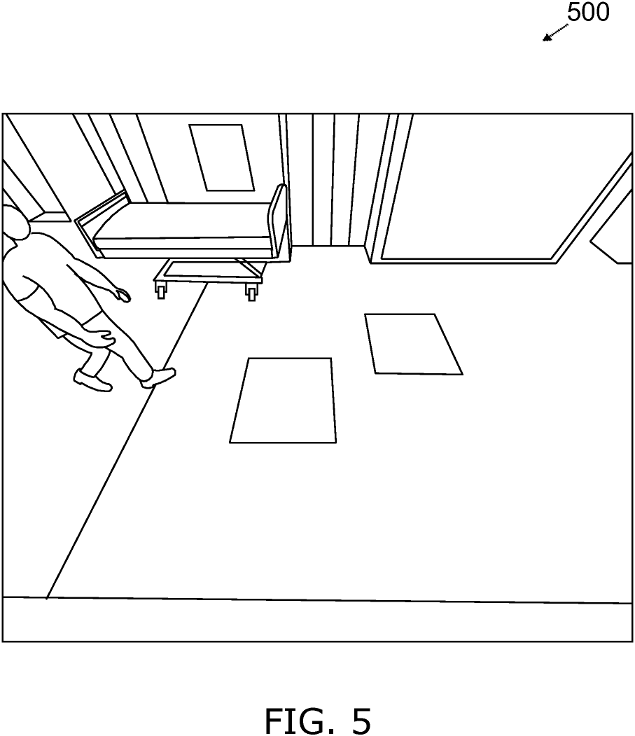

Referring to FIG. 4, there is shown a schematic illustration 400 of a captured and streamed video of a subject in a scan area, in accordance with an embodiment of the present disclosure. As shown the image capturing arrangement, such as the image capturing arrangement 102 of FIG. 1, implemented as a wide-angle (fisheye) camera, captures a non-rectilinear view of the scan area with a 180° vertical angle of view, and a 180° horizontal and diagonal angle of view thereof.

Referring to FIG. 5, there is shown a schematic illustration of a dewarp image 500 of a subject in a scan area, in accordance with an embodiment of the present disclosure. As shown, the dewarp image from a fisheye video is streamed on a mobile app.

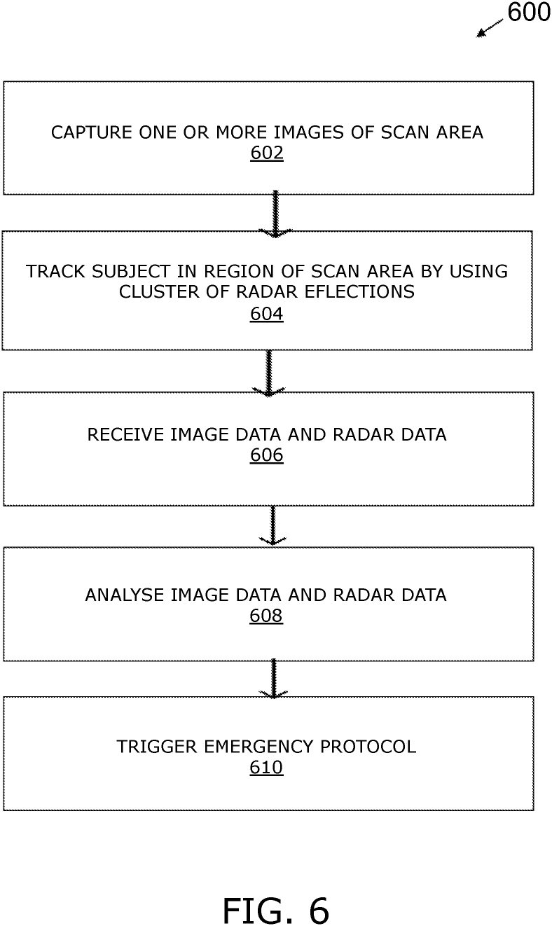

Referring to FIG. 6, there is shown a flowchart 600 of steps of a method of monitoring a subject, in accordance with an embodiment of the present disclosure. At step 602, one or more images of a scan area is captured. At step 604, the subject in a region of the scan area is tracked by using a cluster of radar reflections. The radar reflections track the subject by detecting a macro-movement of the subject, defining a bounding box corresponding to the macro-movement, defining an aspect ratio of the bounding box, and detecting a micro-movement of the subject, when a change in the aspect ratio is observed. At step 606, an image data and a radar data are received. At step 608, the image data and the radar data are analysed to determine the change in the aspect ratio. At step 610, an emergency protocol is triggered when the change in the aspect ratio is observed, or a value corresponding to the micro-movement differs from a predefined range.

The steps 602, 604, 606, 608 and 610 are only illustrative and other alternatives can also be provided where one or more steps are added, one or more steps are removed, or one or more steps are provided in a different sequence without departing from the scope of the claims herein.

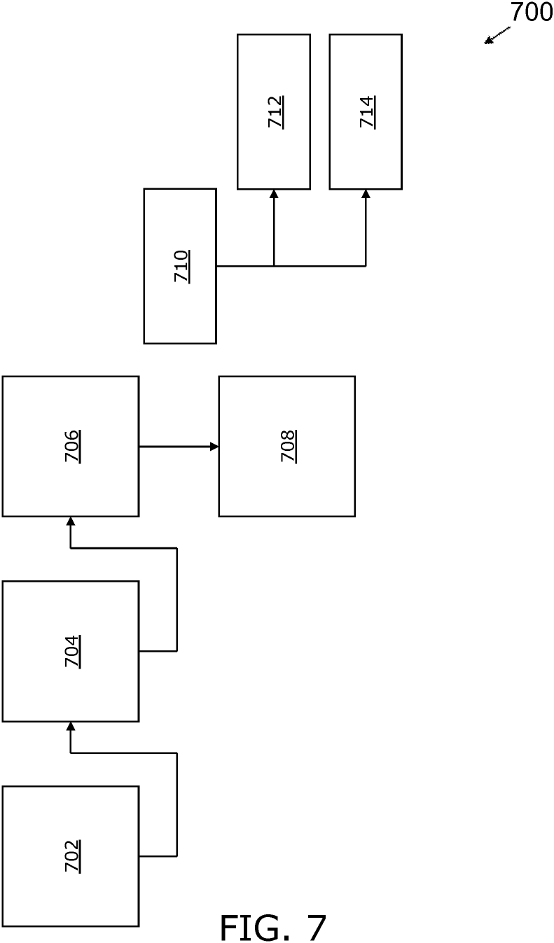

Referring to FIG. 7, there is shown a flowchart 700 illustrating steps of functioning of a radar arrangement, such as the radar arrangement 104 of FIG. 1, in accordance with an embodiment of the present disclosure. At step 702, the radar arrangement is in an idle mode i.e., when no motion is detected by the radar arrangement. In the idle mode, in order to save the power, the display screen is generally in an off-mode and the chirp frequency and frame rate corresponding to the radar arrangement are low. At step 704, the radar arrangement is in a tracking mode. In the tracking mode, the radar arrangement detects a motion of the subject in a region of a scan area and the display screen is turned on. During the tracking mode, the image capturing arrangement, such as the image capturing arrangement 102 of FIG. 1, detects the subject and smoke and/or fire outbreak in the scan area and the image capturing arrangement detects a fire or a smoke. The image capturing arrangement and the radar arrangement coordinate to verify the fall detection. At step 706, the system detects an emergency and loads on the display screen contact list for call mode. At step 708, the radar arrangement defines a bounding box corresponding to the macro-movement, defines an aspect ratio of the bounding box, and detects a micro-movement of the subject, when a change in the aspect ratio is observed. At step 710, the processing arrangement receives an image data and a radar data to initiate a call to a contact person in the contact list by analysing the face and facial features at step 712 and response from the subject at step 714.

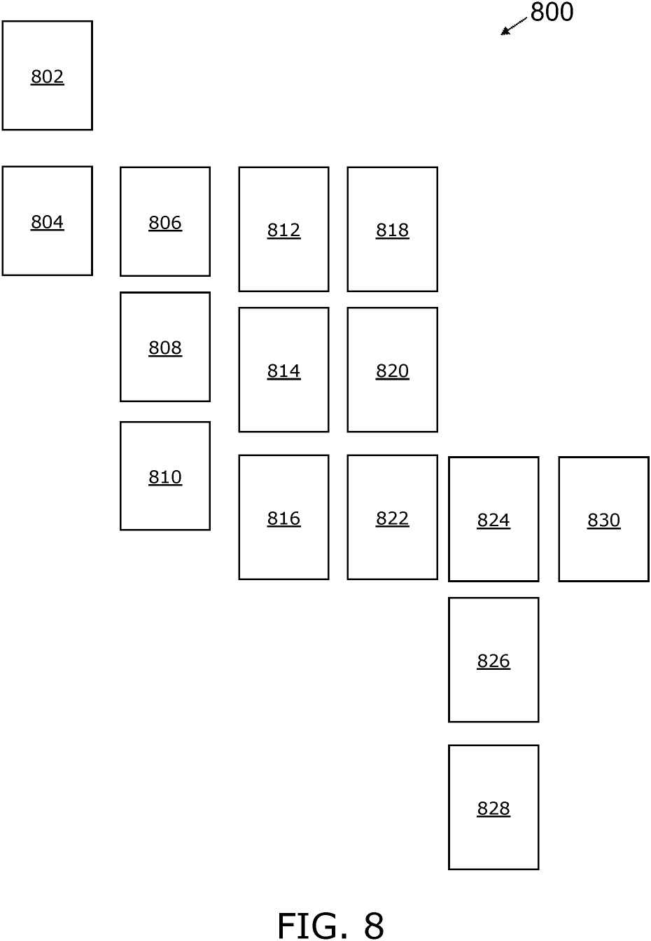

Referring to FIG. 8, there is shown a logic 800 of a two-factor fall-detection, in accordance with an embodiment of the present disclosure. At 802, the subject is tracked using a radar arrangement, such as the radar arrangement 104 of FIG. 1, and a macro-movement of the subject detected. At 804, a bounding box corresponding to the macro-movement is defined and an aspect ratio of the bounding box determined as a ratio of height to width of the bounding box. At 806, 808 and 810, if the aspect ratio is greater than 1.2, the subject is assumed to be standing, if the aspect ratio is less than 0.8, the subject is assumed to be lying down, and if the aspect ratio is in a range between 0.8 and 1.2, the subject is assumed to be sitting, respectively. At 812, 814 and 816, change in the aspect ratio is determined as a function of time, the new aspect ratio is associated with a stance of the subject, such as subject assumed to be lying down, and then running an object recognition algorithm on the image capturing arrangement, such as the image capturing arrangement 102 of FIG. 1, respectively. At 818, 820 and 822, when the radar arrangement detects a change in the aspect ratio of the bounding box as a function of time to be lower than 1 in 1 second for example, then the person is assumed to have fallen, and the radar arrangement is reconfigured to detect micro-movements of the subject, respectively. At 824 and 826, the radar arrangement is configured to detect the micro-movement, and extract information such as heart rate frequency and respiration rate of the subject from the detected micro-movement, respectively. At 828, the emergency protocol is triggered by the radar arrangement. At 830, the radar arrangement provides the final data such as the state of the subject, such as for example, if the person is alive or dead.

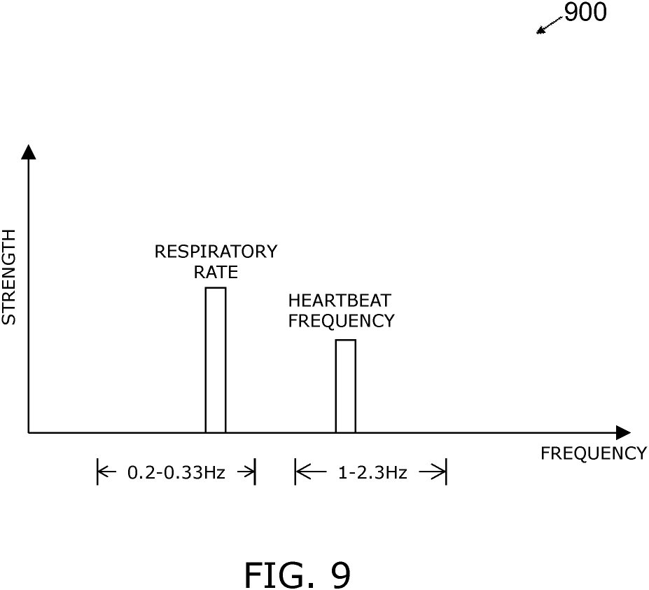

Referring to FIG. 9, illustrated is a graph 900 depicting an exemplary Fast Fourier Transform of micro-movements, in accordance with an embodiment of the present disclosure. As shown, the x axis and y axis of the graph represent the frequency and strength of the micro-movement. Ideally, the frequency of the respiratory rate ranges between 0.2-0.33 Hz and the heartbeat ranges between 1.0-2.3 Hz, while the strength of the respiratory rate is higher than that of the heartbeat. In other words, in FFT of a normal adult, a stronger respiratory peak will be overlaid by a weaker but faster heartbeat peak.

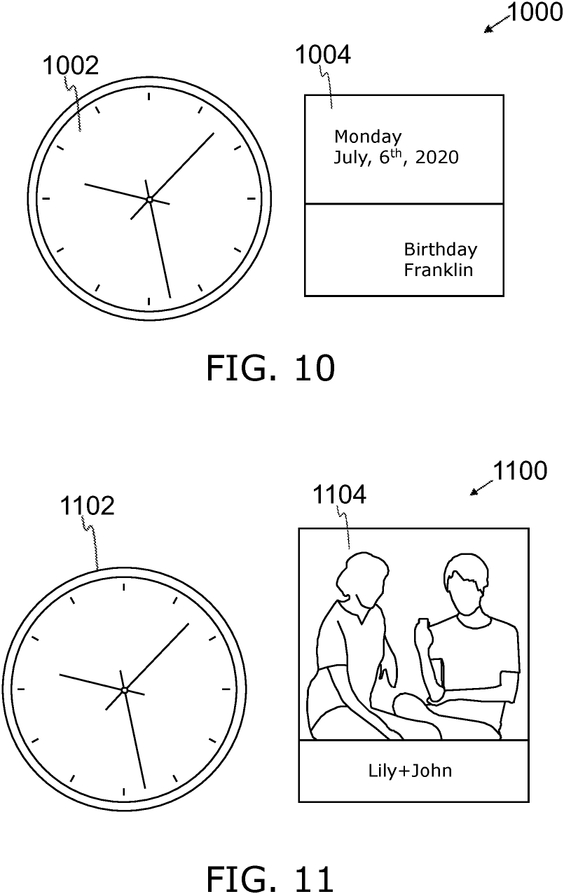

Referring to FIG. 10, there is shown an exemplary illustration 1000 of a display screen for disoriented subjects, in accordance with an embodiment of the present disclosure. As shown, the display screen displays a large customizable wall clock 1002, and an information text box 1004 showing a current day or date, and a reminder from an internal calendar.

Referring to FIG. 11, there is shown an exemplary illustration 1100 of a display screen for a dementia patient, in accordance with an embodiment of the present disclosure. As shown, the display screen displays a large customizable wall clock 1102, and a picture 1104 of with a description taken from a graphics database.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A system for monitoring a subject, the system comprising:
an image capturing arrangement comprising an image sensor configured to capture one or more images of a scan area;
a radar arrangement, operatively coupled to the image capturing arrangement, wherein the radar arrangement is configured to track the subject in a region of the scan area by using a cluster of radar reflections to
detect a macro-movement of the subject,
define a bounding box corresponding to the macro-movement,
define an aspect ratio of the bounding box, and
detect a micro-movement of the subject, when a change in the aspect ratio is observed; and
a processing arrangement configured to
receive an image data from the image capturing arrangement and a radar data from the radar arrangement,
analyse the image data and the radar data to determine the change in the aspect ratio, and
trigger an emergency protocol when
the change in the aspect ratio is observed, or
a value corresponding to the micro-movement differs from a predefined range.

2. A system according to claim 1, further comprising
a communication interface having
a display screen configured to display text or graphics thereon;
a microphone configured to receive an audio input from the subject, and
a speaker configured to provide an audio output to the subject;
a memory module configured to store data associated with the subject; and
a network interface.

3. A system according to claim 1, wherein the processing arrangement is further configured to implement Fourier analysis algorithms to analyze the micro-movement of the subject.

4. A system according to claim 1, wherein the processing arrangement is further configured to implement an artificial-intelligence-based object recognition algorithm to analyze the radar data and trigger the emergency protocol.

5. A system according to any of the preceding claims, wherein the emergency protocol triggers an emergency alert, wherein the emergency alert is contacting an authorised carer of the subject.

6. A system according to any of the preceding claims, wherein the image capturing arrangement is arranged to have the scan area within a field of view thereof, and wherein the image capturing arrangement is configured to capture the one or more images when the subject is positioned within the scan area.

7. A system according to any of the preceding claims, wherein the image capturing arrangement is a wide-angle camera.

8. A system according to any of the preceding claims, wherein the wide-angle camera is a fisheye camera.

9. A system according to any of the preceding claims, wherein the image capturing arrangement further comprises an illuminator configured to illuminate the scan area during capturing of the one or more images.

10. A system according to claim 1, wherein the processing arrangement is further configured to dewarp the one or more images.

11. A system according to claim 1, wherein one or more slave devices are arranged in one or more areas outside the scan area, wherein the one or more slave devices are configured to provide at least one of: the image data or the radar data corresponding to the one or more areas to the processing arrangement.

12. A method for monitoring a subject using a system of any of the preceding claims, the method comprising:
capturing one or more images of a scan area;
tracking the subject in a region of the scan area by using a cluster of radar reflections for
detecting a macro-movement of the subject,
defining a bounding box corresponding to the macro-movement,
defining an aspect ratio of the bounding box, and
detecting a micro-movement of the subject, when a change in the aspect ratio is observed;
receiving an image data and a radar data;
analysing the image data and the radar data to determine the change in the aspect ratio; and
triggering an emergency protocol when
the change in the aspect ratio is observed, or
a value corresponding to the micro-movement differs from a predefined range.

13. A method according to claim 12, further comprising storing data associated with the subject in a memory module.

14. A method according to claim 12, further comprising implementing Fourier analysis algorithms to analyze the micro-movement of the subject.

15. A method according to claim 12, further comprising implementing an artificial-intelligence-based object recognition algorithm to analyze the radar data and trigger the emergency protocol.

16. A method according to any of the claim 12 to 15, wherein the emergency protocol triggers an emergency alert, wherein the emergency alert is contacting an authorised carer of the subject.

17. A method according to any of the preceding claims, wherein the method comprises arranging a image capturing arrangement to have the scan area within a field of view thereof, and wherein the image capturing arrangement is configured to capture the one or more images when the subject is positioned within the scan area.

18. A method according to claim 12, further comprising dewarping of the one or more images.

19. A method according to claim 12, further comprising arranging one or more slave devices in one or more areas outside the scan area, wherein the one or more slave devices are configured to provide at least one of: the image data or the radar data corresponding to the one or more areas to the processing arrangement.

20. A computer program product comprising a non-transitory computer-readable storage medium having computer-readable instructions stored thereon, the computer-readable instructions being executable by a processing arrangement comprising multiple processing threads to execute a method as claimed in any one of claims 12-19.
